(19) United States
(12) Patent Application Publication
(10) Pub. No.: US 2025/0392595 A1
(43) Pub. Date: Dec. 25, 2025

(54) REASONING AND INTENT BASED AUTHORISATION SYSTEM AND A METHOD THEREOF

(71) Applicant: ABLUVA PRIVATE LIMITED, Pune (IN)

(72) Inventor: Amit Kumar GAUTAM, Pune (IN)

(21) Appl. No.: 19/245,497

(22) Filed: Jun. 23, 2025

Related U.S. Application Data
(60) Provisional application No. 63/663,722, filed on Jun. 25, 2024.

(51) Int. Cl. H04L 9/40

(52) U.S. Cl. CPC H04L 63/10

(57) ABSTRACT

An authorization system and related method is disclosed. The system receives an access request from a requester (human or machine). The system performs a series of steps in order to dynamically determine whether access has to be provided to the requester. The requester may be an unknown entity and access related policies may not be defined. The series of steps for dynamically granting access may include generating one or more relational parameters, generating one or more reasoning indicators, receiving, from the device associated with the requester, response inputs on a set of tasks associated with the requested resource, and validating the one or more reasoning indicators using the one or more relational parameters and the response inputs. Upon successful validation, access can be granted to the requester with least privileges required for the access.

### FIELD OF THE INVENTION

The present disclosure relates to authorisation systems. More particularly, the present disclosure relates to a reasoning and intent based authorisation system.

### BACKGROUND

In today's digital age, safeguarding valuable digital assets and sensitive information (data) is crucial. Authorisation systems play an essential role for managing access to the data and information, i.e., determining what actions or resources are allowed to be accessed by entities. This involves checking the permissions and privileges of the entities. The authorisation systems ensure that the entities are granted access to data and resources based on the assigned permissions, thereby maintaining the security and integrity of the data and information.

A Data Access Control (DAC) system may be an example of authorization systems that decides which entities can access the data based on certain factors like the entities requesting for access, type of data being accessed, extent of access being requested, etc. That is, DAC systems require the requester's attributes (e.g. group, role, location, etc.) and access characteristics (e.g. sensitivity, features, location, etc.) of the data. However, conventional DAC systems have their limitations.

DAC systems require information about the entities asking for access, their attributes, and the rules for access to be set up (created and linked) beforehand. That is, for a new entity requesting access or an access request that is not anticipated, the DAC system may prove ineffective. For instance, the DAC system may not have the capability to dynamically grant access to new (unknown) requesters or even decide on a least amount of access needed for a request instantaneously. Similarly, in cases where access rules and policies are not set up, the system cannot dynamically authorize the requesters.

As an example, members of support team in an organization are tasked with resolving issues within the organization's systems. Depending on the specific task at hand, the support team might need access to different parts of the organization's data-stores or other resources. Since it is difficult to precisely predict the type of access and data that will be required by the support team, support team members may be granted broader access privileges than strictly necessary. This can make the data of the organization vulnerable to attacks because it increases the ways someone could misuse that access.

Thus, current authorization systems have the drawbacks of rigidity and inability to adapt to new or unpredictable requests, leading to security vulnerabilities. There is a pressing need for an enhanced dynamic authorization system that automatically manages access based on multiple parameters of the requesters.

Therefore, in view of the above-mentioned problems, it is desirable to provide a system and a method for autonomous authorization systems based on reasoning and intent.

### SUMMARY

In an aspect, the present invention is directed to a computer-implemented method for authorizing access to a resource in a computing environment. The method comprises receiving an access request from a device associated with a requester for accessing the resource. The method comprises generating one or more relational parameters associated with the requester, the requested resource, and the access request, the one or more relational parameters including historical contextual information and intent indicators. The method comprises generating one or more reasoning indicators indicative of a reason for the access request, based on events associated with one or more of the requested resource, the computing environment, and external systems. The method comprises receiving response inputs on a set of tasks associated with the requested resource, the tasks being indicative of knowledge required to access the requested resource. The method comprises validating the one or more reasoning indicators using the one or more relational parameters and the response inputs, wherein the validation includes evaluating an alignment between the one or more reasoning indicators, the one or more relational parameters, and the response inputs. The method comprises, based on a determination that the validation is successful, granting access to the requested resource with a set of privileges that corresponds to least privileges required for the access.

In an aspect, the present invention is directed to a system for authorizing access to a resource in a computing environment. The system comprises one or more processors and a memory storing instructions executed by the one or more processors. The instructions cause the one or more processors to be configured to receive an access request from a device associated with a requester for accessing the resource. The one or more processors are further configured to generate one or more relational parameters associated with the requester, the requested resource, and the access request, the one or more relational parameters including historical contextual information and intent indicators. The one or more processors are further configured to generate one or more reasoning indicators indicative of a reason for the access request, based on events associated with one or more of the requested resource, the computing environment, and external systems. The one or more processors are further configured to receive response inputs on a set of tasks associated with the requested resource, the tasks being indicative of knowledge required to access the requested resource. The one or more processors are further configured to validate the one or more reasoning indicators using the one or more relational parameters and the response inputs, wherein the validation includes evaluating an alignment between the one or more reasoning indicators, the one or more relational parameters, and the response inputs. The one or more processors are further configured to, based on a determination that the validation is successful, grant access to the requested resource with a set of privileges that corresponds to least privileges required for the access.

In an aspect, the present invention is directed to a non-transitory computer-readable storage medium comprising instructions executable by a processor. The instructions cause the processor to perform or control performance of operations. The operations comprise receiving an access request from a device associated with a requester for accessing a resource in a computing environment. The operations comprise generating one or more relational parameters associated with the requester, the requested resource, and the access request, the one or more relational parameters including historical contextual information and intent indicators. The operations comprise generating one or more reasoning indicators indicative of a reason for the access request, based on events associated with one or more of the requested resource, the computing environment, and external systems. The operations comprise receiving response inputs on a set of tasks associated with the requested resource, the tasks being indicative of knowledge required to access the requested resource. The operations comprise validating the one or more reasoning indicators using the one or more relational parameters and the response inputs, wherein the validation includes evaluating an alignment between the one or more reasoning indicators, the one or more relational parameters, and the response inputs. The operations comprise, based on a determination that the validation is successful, granting access to the requested resource with a set of privileges that corresponds to least privileges required for the access.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an environment comprising a system for reasoning and intent based dynamic access management, in accordance with an embodiment of the present disclosure;

FIG. 2 illustrates a block diagram of the system of FIG. 1, in accordance with an embodiment of the present disclosure;

FIG. 3 illustrates a process flow depicting operations among a set of modules of the system of FIG. 2, in accordance with an embodiment of the present disclosure;

FIG. 4 illustrates a process flow depicting a method associated with the reasoning and intent based authorization system, in accordance with an embodiment of the present disclosure; and

FIG. 5 illustrates a process flow depicting a method associated with authorizing access to a resource in a computing environment, in accordance with an embodiment of the present disclosure.

Further, skilled artisans will appreciate that elements in the drawings are illustrated for simplicity and may not have necessarily been drawn to scale.

Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION OF FIGURES

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure will be described below in detail with reference to the accompanying drawings.

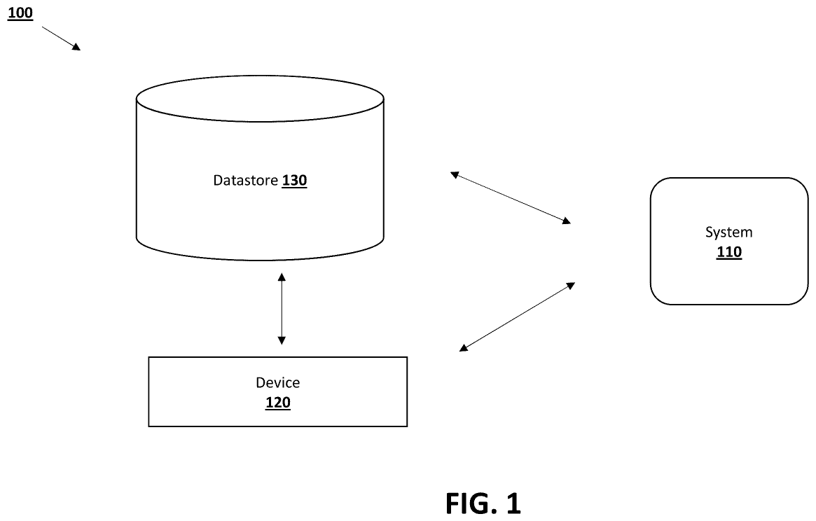

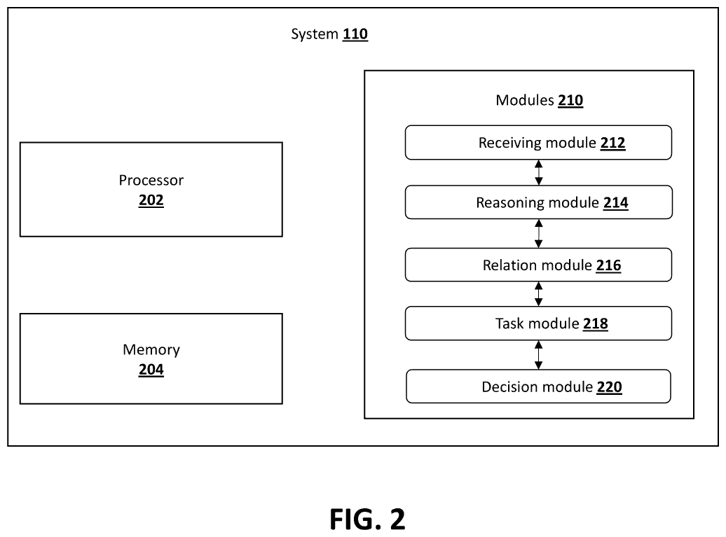

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

FIG. 1 illustrates a block diagram of a computing environment 100 comprising an authorization system 110 for autonomously and dynamically verifying an accessor/requester and managing accesses to data and information, according to an embodiment of the present invention. The computing environment 100 may refer to an ecosystem related to an organization. The computing environment 100 comprises one or more devices 120 associated with the accessor/requester (accessor device or requester device) and in communication with the system 110. In an embodiment, the system 110 may be implemented in conjunction with the device 120. For instance, the system 110 may be integrated within the device 120. In another embodiment, the system 110 may be implemented in a cloud-based server remote from the device 120. In such a scenario, the system 110 may be in communication with the device 120 via a suitable communication network.

The accessor/requester in the present disclosure may refer to a user (human) requesting access to data via the device 120 or to any other entity (e.g., machine or software) associated with the device 120 and requesting access to the data via the device 120.

The data may refer to sensitive information or other digital assets within the environment 100. For instance, the data may refer to data of an organization. In an embodiment, the data may be stored in a datastore 130. The datastore 130 may be in communication with the device 120. The device 120, the system 110, and the datastore 130 may form part of the organization's ecosystem. The datastores may include cloud-based databases, data-center based databases, data lakes, and the like. The datastores may be accessed using a defined data access language.

The device 120 may comprises a user interface allowing the accessor to access the datastore 130. In an exemplary embodiment, the device 120 may include a laptop computer, a desktop computer, a smartphone, and the like. Further, the network connecting the device 120 with the datastore 130 and the system 110 may include a wireless network or a wired network. For example, the network corresponds to Wi-Fi, cellular networks such as 3G, 4G, 5G, pre-5G, 6G network, or any other wireless communication network.

FIG. 2 illustrates a block diagram of the system 110 depicted in FIG. 1. The system 110 includes one or more processors 202 (alternatively referred to as a ‘processor 202’) and a memory 204. As a non-limiting example, the one or more processors 202 are a single processing unit or a set of units each including multiple computing units. The one or more processors 202 are implemented as one or more microprocessors, microcomputers, microcontrollers, digital signal processors, central processing units, state machines, logic circuitries, and/or any devices that manipulate signals based on operational instructions (computer-readable instructions) stored in the memory 204. Among other capabilities, the one or more processors 202 are configured to fetch and execute computer-readable instructions and data stored in the memory 204. The one or more processors 202 include one or a plurality of processors. The plurality of processors are further implemented as a general-purpose processor, such as a central processing unit (CPU), an application processor (AP), or the like, a graphics-only processing unit, such as a graphics processing unit (GPU), a visual processing unit (VPU), and/or an AI-dedicated processor such as a neural processing unit (NPU). The plurality of processors control the processing of the input data in accordance with a predefined operating rule or an artificial intelligence (AI) model stored in the memory 204. The predefined operating rule or the AI model is provided through training or learning.

The one or more processors 202 are disposed in communication with one or more input/output (I/O) devices via an Input/Output (I/O) interface. The I/O interface employs communication code-division multiple access (CDMA), high-speed packet access (HSPA+), global system for mobile communications (GSM), long-term evolution (LTE), WiMax, or the like, etc. In another embodiment of the present invention, the I/O interface employs ethernet, industrial wireless Local Area Network (LAN), Process Field Bus (PROFIBUS), Actuator Sensor (AS) Interface, and the like.

In some embodiments, the memory 204 is communicatively coupled to the one or more processors 202. The memory 204 is configured to store instructions executable by the one or more processors 202. In one embodiment, the memory 204 communicates via a bus within the system 110. The memory 204 includes, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory includes a cache or random-access memory (RAM) for the one or more processors 202.

In alternative examples, the memory 204 is separate from the one or more processors 202 such as a cache memory of a processor, the system memory, or other memory. The memory 204 is an external storage device or a datastore for storing data. The memory 204 is operable to store instructions executable by the one or more processors 202. The functions, acts or tasks illustrated in the figures or described are performed by the programmed processor for executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies include multiprocessing, multitasking, parallel processing, and the like.

The memory 204 may include an operating system for performing one or more tasks of the system 110, as performed by a generic operating system in the communications domain. In one embodiment, the memory 204 is configured to store the information as required by the one or more processors 202 to perform one or more functions for validating accessors based on data access language patterns and query execution analysis.

The system 110 further comprises a set of modules 210. The processor 202 may be configured to perform designated functions in conjunction with the memory 204 and the set of modules 210. In some embodiments, the set of modules 210 may be included within the memory 204. In some embodiments, the set of modules 210 may include a set of instructions that may be executed to cause the system 110, in particular, the processor 202, to perform any one or more of the methods disclosed herein. The set of modules 210 in conjunction with the processor 202 may be configured to perform the steps of the present disclosure using the data stored in the memory 204, as discussed throughout this disclosure. In an embodiment, each of the set of modules 210 may be software modules within the memory 204. In an embodiment, each of the set of modules 210 may be hardware units that may be outside the memory 204. The set of modules 210 may include a receiving module 212, a reasoning module 214, a relation module 216, a task module 218, and a decision module 220. It may be noted herein that the functionality mentioned as being performed by the modules 210 may be understood to be performed in conjunction with the processor 202.

In an embodiment, the system 110 is provided in a distributed manner, in that, one or more components and/or functionalities of the system 110 are provided through an electronic device, and one or more components and/or functionalities of the system 110 may be provided through a cloud-based unit, such as, a cloud storage or a cloud-based server. In a non-limiting example, the memory 204 may be provided through the cloud storage and the one or more processors 202 may be integrated with an electronic device (such as the device 120).

Further, the present invention also contemplates a computer-program product that includes instructions or receives and executes instructions responsive to a propagated signal. Further, the instructions may be transmitted or received over the network via a communication port or interface or using a bus (not shown). The communication port or interface may be a part of the one or more processors 202 or may be a separate component. The communication port may be created in software or may be a physical connection in hardware. The communication port may be configured to connect with the network, external media, the display, or any other components in the system 110. The connection with the network may be a physical connection, such as a wired ethernet connection, or may be established wirelessly. Likewise, the additional connections with other components of the system 110 may be physical or may be established wirelessly. The network may alternatively be directly connected to the bus. For the sake of brevity, the architecture, and standard operations of the memory 204 and the one or more processors 202 are not discussed in detail.

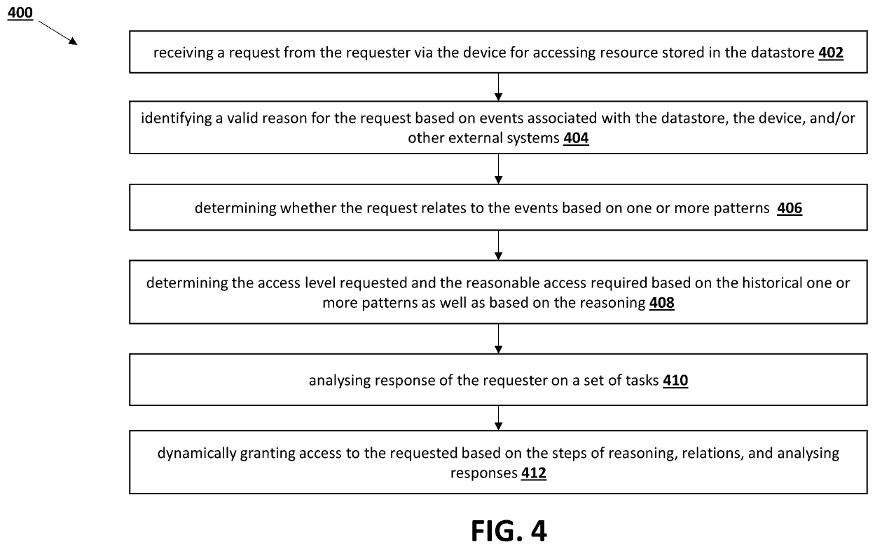

In an embodiment, the computer-program product, having machine-readable instructions stored therein, when executed by one or more processors 202, cause the one or more processors 202 to perform a method as elaborated in subsequent paragraphs at least with reference to FIG. 4.

Further, the present invention also contemplates a non-transitory computer-readable medium encoded with executable instructions. The executable instructions, when executed by one or more processors 202, cause the one or more processors 202 to perform a method as elaborated in subsequent paragraphs at least with reference to FIG. 4. Examples of computer-readable mediums include non-volatile, hard-coded type mediums such as read-only memories (ROMs) or erasable, electrically programmable read-only memories (EEPROMs), and user-recordable type mediums such as floppy disks, hard disk drives and compact disk read-only memories (CD-ROMs) or digital versatile disks (DVDs).

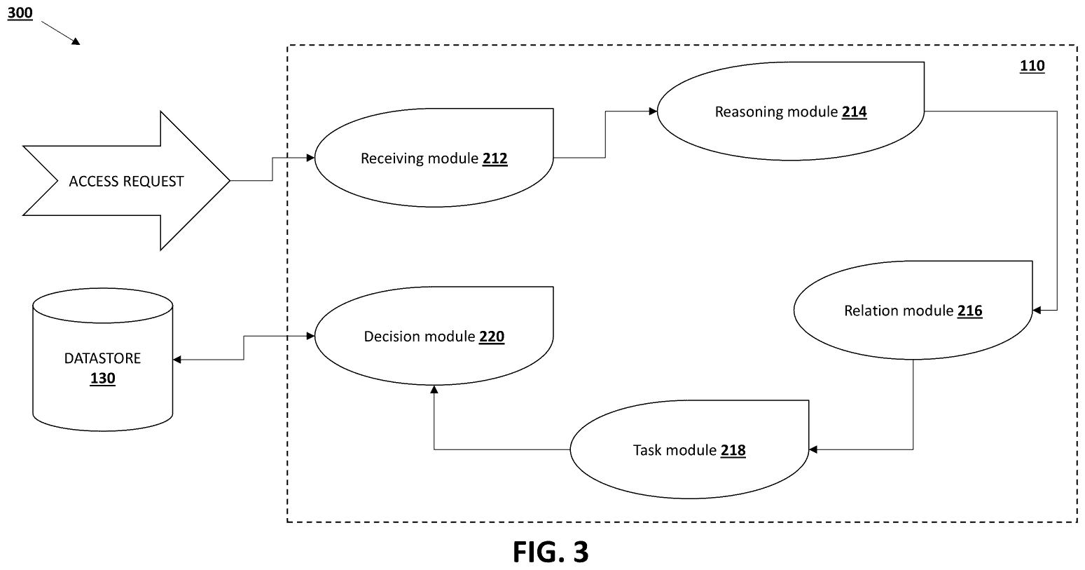

FIG. 3 illustrates a process flow 300 depicting operations among the set of modules 210 of the system 110. Details of the invention will now be described collectively with FIGS. 1-3.

The terms ‘requester,’ ‘accessor,’ and ‘user’ may be used interchangeably. The terms ‘data’ and ‘resource’ may be used interchangeably. As used herein, the term ‘resource’ may refer to data, services, computing functions, or other digital or computational assets accessible within a computing environment or its connected external systems, e.g., the environment 100 along with connected external systems.

The processor 202 in conjunction with the receiving module 212 may be configured to receive a request from the requester via the device 120. As mentioned above, the requester may be a user or a machine (software). The request may be indicative of an access request for accessing data or resource in a computing environment, for instance, the environment 100. In an embodiment, the resource may be stored in the datastore 130. It is to be noted that the terms ‘data’, ‘information’, and ‘resource’ may be used interchangeably in the present disclosure.

In an embodiment, the data may be represented in a connected form through temporal graphs, vectors or similar mechanisms. That is, the datastore 130 may store data in an inter-connected manner in such embodiments. Such interconnected representations can help in building contextual information for access grant decision making. For instance, data may be interconnected through edges or through cosine similarity. In alternative embodiments, the datastore 130 may store data in relational or unstructured manner.

Upon receiving the request from the requester to access the resource in the computing environment, the processor 202 may be configured to perform a series of steps in order to determine whether access has to be provided to the requester. In an embodiment, the requester may be an unknown entity or a new entity requesting for access. In an embodiment, access related policies may not be defined for the system 110 in case the requester is unknown, and thus, it is important to perform the series of steps prior to allowing access to the unknown entity. In other embodiments, the requester may be a known entity (e.g., having a password or signature) and the series of steps may be performed as an additional check to reinforce authorisation.

The series of steps for dynamically granting access may be performed to evaluate the access request in order to establish an understanding of intent, historical context, and reasoning that justifies the access. The series of steps may generally include identifying a valid reason for the access request (interchangeably referred to as ‘the request’), determining an intent for the access request, comparing access level requested with past requests and grant patterns, and, analysing response of requesters on a set of tasks that can only be successfully performed by someone with knowledge of the requested resource.

The processor 202 in conjunction with the reasoning module 214 may be configured to identify a valid reason for the request based on one or more events. That is, the reasoning module 214 may determine reasoning indicators by deducing possible reason for which the request to access the resource in the computing environment, such as, resource stored in the datastore 130, may be received. The reasoning indicators may be indicative of valid reasons for the request from the requester. The reasoning indicators may refer to information that conveys a rationale or justification for requesting access to a resource in the computing environment. The events may be associated directly or indirectly with the computing environment, the datastore 130, the device 120, and/or other external systems. The events may include, as non-limiting examples, events in connected systems, events in isolated systems, events related to requester, events related to the resource, events related directly or directly to any other entity linked to the resource or the requester, and the like.

In some embodiments, the events associated with the datastore 130 may include, in non-limiting examples, creation of a node linked to another node that requester already have access to, schema or permission changes granting user permission in the datastore, etc. In some embodiments, the events associated with the device may include, in non-limiting examples, device assignment, location change, IP address change, etc.

In some embodiments, the events associated with external systems may include, in non-limiting examples, ticket assigned to requester (e.g., for incident response or support), approval in purchase or expense systems, requester added to a project via project management systems, role or access granted in a Human Resource (HR) system (e.g., new team assignment), access granted or revoked in a third-party Software as a service (SaaS), etc. The external systems may include, in non-limiting examples, task management systems, workflow engines, audit trails and logs engines, etc.

The events may be indicative of implicit or explicit reasoning for the request to access the resource. The processor 202 in conjunction with the reasoning module 214 may obtain information regarding the events. The information related to the events may be obtained from the device 120, from the external systems in communication with the device 120 or the computing environment, and/or from the datastore 130. For instance, the event may be existence of a ticket assigned to a support person with relatable context indicating sufficient reason for requesting access. The ticket may mention, for example, ‘issue with sales invoice’ and support person is also requesting resources/data related to sales invoices. Sufficient reason to access the resource can thus be deduced.

Similarly, if a user is assigned a billing-related task, the event of task assignment can be indicative of justifiable reason for the user to send an access request to access billing data stored in the datastore 130. In another example, if a purchase order has been approved, the event of approval may be indicative of justifiable reason for the corresponding vendor to access supplier information stored in the datastore 130.

In some embodiments, in case of multiple access requests from the requester over a course of time, the processor 202 may map currently identified reason for access with approved reasons identified for prior access requests. In some embodiments, in case of multiple access requests from the requester over a course of time, the processor 202 may align currently identified reason for access with prior consistent behaviour, in that, prior behaviour of requester being justified enhances trust for the requester sending the current access request.

Further, the processor 202 in conjunction with the relation module 216 may be configured to determine relational parameters associated with the requester, the requested resource, and/or the access request, and optionally the overall computing environment, the device 120, and/or other patterns. The relational parameters may be indicative of context and intent associated with the access request and/or the events. For instance, the relation module 216 may determine whether the request received from the requester relates to the events and/or the access request. The relational parameters may refer to attributes linking the requester and the requested resource, such as historical access records, user roles, similarity measures to past requester profiles, semantic distance in an ontology or knowledge graph, etc.

The relational parameters may include one or more patterns. The one or more patterns may include, for instance, temporal patterns (temporal characteristics of access), data patterns (data characteristics), access patterns (access request characteristics), patterns related to request, patterns related to events, patterns related to relations between events and resources, etc. In an embodiment, the access patterns may include scope of access, access operations, constraints, and the like. In an embodiment, the one or more patterns may be some relation or proximity to the events.

In an embodiment, the one or more patterns may include contextual evidence in the events and access request. The contextual evidence may be determined by the processor 202 based on Natural Language Processing (NLP) techniques (e.g., large language models). As an example, the requester being assigned a ticket about billing failure has sent an access request for access to billing table stored in the datastore 130, indicates the contextual evidence in the events and the request.

In an embodiment, the one or more patterns may include relational evidence associated with data stored in the datastore 130. As an example, the requester may have access to first and second nodes in the datastore (e.g., Molecule node and Oncology node) and a new node is added that connects both the first and second nodes in the datastore, thereby indicating relational evidence.

In some embodiments, the relational parameters may include historical contextual information related to access request, the requester, and the requested resource. The historical contextual information may be associated with the requested resource (i.e., data in the datastore that is requested to be accessed by the requester) and/or on other resources similar to the requested resource within the computing environment (e.g., data similar in usage, domain, affiliation, sensitivity, name, etc. to the data in the datastore that is requested to be accessed by the requester). The historical contextual information may be associated with the current requester and/or other requesters similar to the current requester. The historical contextual information may be associated with current access request and/or other similar access requests. For instance, the historical contextual information may be indicative of which user personas have previously accessed similar resources, what access was granted in similar scenarios previously, what operational or organizational boundaries (departments, projects, roles) framed past access requests, etc.

In some embodiments, similarity between resources or requesters may be determined using one or more computational models. For example, similarity between requesters may be determined based on overlapping access histories, role proximity in an organizational graph, or embedding-based profile similarity (e.g., cosine similarity of vectorized behaviour profiles). Similarity between resources may be computed using metadata (e.g., tags, owners, sensitivity levels), content-based similarity (e.g., topic modelling or embedding distances), access co-occurrence patterns in historical data, etc.

As an example, whenever a user is added to a HR system, the user is given access to a first level of IT data, thereby indicating the historical contextual information. As another example, request patterns of historical requests sent by the current requester or by other requesters similar (implicitly or explicitly) to the current requester can be obtained and modelled to define the historical contextual information.

In some embodiments, the relational parameters may include intent indicators associated with the access request. The intent indicators may be determined by the processor 202 by analyzing the access request received from the requester. In an embodiment, the intent indicators may be indicative of scope of resources being requested for access. The intent indicators may capture behavioural patterns and contextual cues indicating the purpose of access. These may include timestamp correlations, sequence of access actions, frequency of interaction with related resources, or alignment with known access patterns of similar users. The scope of resources may include which tables, objects, etc. within the datastore 130 are being requested for access. In an embodiment, the intent indicators may be indicative of request context, for example, how the access is being made (e.g., method of request (API (Application Programming Interface), UI (User Interface), CLI (Command Line Interface)), time of request, frequency of requests, location of request, etc.

In an embodiment, the intent indicators may be indicative of extent of privileges required (e.g., read, write, delete) for the resources or the type of action being attempted. The processor 202 in conjunction with the relation module 216 may determine the extent of privileges based on the access request received. Each access request may require a different combination and level of privileges. The extent of privileges may indicate the essential set of privileges and their levels which must be granted to authorise an action.

In many cases, the minimum necessary privileges to perform a specific action are less than the privileges typically provisioned for that role or requester. In some embodiments, the relation module 216 may further be configured to deduce the least privileges required for the requested access. Thus, it is ensured that the least privileges are only granted. In an embodiment, the relation module 216 may access other relational parameters, such as historical contextual information and patterns, related to past least privileges granted for the requested resources or other similar resources. Based on the historic contextual information and patterns (e.g., actions and the privileges of previous requesters), the relation module 216 may automatically determine a set of privileges and their needed levels required for an action, which may be the least privileges required for that action. As an example, a developer may be granted SELECT, INSERT, UPDATE, DELETE on an entire database schema during development, however, for a monitoring job that checks system health, only SELECT on specific metadata tables (e.g., pg_stat_activity) is needed, which defines the least privileges required for the monitoring job.

Further, the processor 202 in conjunction with the task module 218 may be configured to analyse response of the requester on a set of tasks associated with the requested resource (and/or similar resources) that can only be successfully performed by someone with knowledge of the requested resource (and/or similar resources within the computing environment). That is, the task module 218 analyses results of a series of actions performed by the requester that can only be performed accurately if the requester known the underlying information associated with the requested resource or similar resources.

In some embodiments, the set of tasks may be pre-defined and stored in the memory. In some embodiments, the set of tasks may be dynamically generated by the task module 218. The set of tasks may be generated based on the received (current) access request and the relational parameters, such as the patterns and/or the historical contextual information related to the requester or related to other requesters similar to the current requester. In some embodiments, the task module 218 may generate tasks dynamically using rule-based systems or AI/ML models. In an example, tasks may be formulated based on a knowledge graph traversal originating from the requested resource, selecting adjacent nodes (concepts) as question topics. In another example, LLM-based models may be used to create questions aligned with the historical role or prior access activities of the requester. In some embodiments, the generated tasks may be automatically labelled for correct and incorrect outcomes to be used for evaluating the responses of the requester.

The processor 202 in conjunction with the task module 218 may be configured to provide the set of tasks to the requester. In an embodiment, the set of tasks may be provided to the requester via the device 120. For instance, the processor 202 may retrieve the pre-defined tasks or dynamically generate the tasks to be provided to the requester. In some examples, the set of tasks may be displayed on an interface of the device 120. In other examples, the set of tasks may be provided as audio, video, haptic data, or any other mode.

The processor 202 in conjunction with the task module 218 may be configured to receive response inputs from the requester, the response inputs being indicative of the responses of the requester on the provided set of tasks.

In some embodiments, the response inputs on the set of tasks may be received directly or indirectly from the device 120 associated with the requester. In some embodiments, the response inputs on the set of tasks may be received from a device associated with the requester being a user or a machine. In other embodiments, the response inputs may be obtained/sourced from other systems, modules, or agents, in communication with the requester or the device 120, that possess or simulate knowledge required to complete the set of tasks. For example, a task such as monthly invoice generation may require customer information and rate card data, which may be sourced from one or more knowledge systems or enterprise software modules.

In an embodiment, the set of tasks may include a series of questions about statistical distribution of the data (resource), data acquisition process, data processing process, data ownership or any specific information of a data point.

In another embodiment, the set of tasks may include zero-knowledge-proof (ZKP) to establish that the requester has knowledge of the requested resource.

Accordingly, the task module 218 assesses the knowledge of the requester related to the requested resource by analysing responses of the requester on the set of tasks and evaluating correctness of the responses of the requester based on the labelled correct and incorrect outcomes.

Further, the processor 202 in conjunction with the decision module 220 may be configured to validate the reasoning indicators using the relational parameters and response on the set of tasks, and dynamically grant access to the requester based on the outputs of the reasoning module 214, the relation module 216, and the task module 218. In an embodiment, the decision module 220 may include a weighted model, a deep learning model, and other similar mechanism. The decision module 220 may establish that access can be linked to a valid reason and need based on events in the ecosystem (environment 100) based on the reasoning indicators. Further, the decision module 220 may establish that the patterns of access and limits have been granted in the past based on the relational parameters (e.g., historical contextual information and patterns). Furthermore, the decision module 220 may establish that the requester is familiar with the requested resource based on the responses on the set of tasks. Accordingly, the validation includes evaluating an alignment between the reason for access (reasoning indicators), the requester knowledge (responses on set of tasks), and patterns of access (relational parameters). Based on the validation, dynamic access can be provided to the requester in an autonomous manner. When the decision module validates the reasoning indicators using the relational parameters and response on the set of tasks, a successful validation can be achieved. In case the decision module could not validate the reasoning indicators using the relational parameters and response on the set of tasks, an unsuccessful validation can be achieved.

In some embodiments, the decision module 220 may determine access scores for validating the reasoning indicators based on the relational parameters and response on the set of tasks and evaluating the alignment. The decision module 220 may determine the access scores for the reasoning indicators and utilize a proof of access graph for validation. The proof of access graph may be a graph-based or mathematical model (e.g., probabilistic model) defining a threshold of conditions to allow access to the resources in the computing environment (e.g., in the datastore 130). An example of threshold of conditions can be considered that historically, credit info access has only been authorised to those users who had at least admin level access to billing portfolio and have been in that role for more than a year. The decision module 220 may be configured to compare the access scores indicative of level of validation of the reasoning indicators. In case the access scores are beyond the threshold of conditions, the validation may be considered to be successful. In case the access scores are not beyond the threshold of conditions, the validation may be considered to be unsuccessful.

The system 110 may thus implement a probabilistic proof of access graph-based model to quantify and visualize the alignment of reason and intent between requesters and resources in the computing environment (stored in the datastore 130). In an embodiment, the relation module 216 may construct and maintain the proof of access graph depicting historical alignment of reasons and intents with access to resources and the likelihood that the reason and intent of the requester aligns with access to the requested resource. The processor 202 may utilize the graph to detect anomalous or unauthorized access attempts by identifying access requests with low-probability reason and intent alignment.

In some embodiments, access scores may be determined based on logical methods to match the reasoning indicators with relational parameters (e.g., intent indicators) including but not limited to sensitivity level methods, action-justification coherence, entity granularity consistency, and temporal validity.

In some embodiments, access scores may be determined based on technological methods to match the reasoning indicators with relational parameters (e.g., intent indicators) including but not limited to LLM-based semantic similarity, vector embedding cross-matching, quantitative methods, ontology or graph matching, etc.

In some embodiments, the processor 202 in conjunction with the decision module 220 may be configured to grant access to the requested resource based on the determination that the validation is successful. In some embodiments, the processor 202 in conjunction with the decision module 220 may be configured to deny access to the requested resource based on the determination that the validation is unsuccessful.

In some embodiments, the access to the requested resource that is granted may take into consideration the determined set of privileges and their needed levels. In some embodiments, the access may be granted with the least privileges required for the access.

In an embodiment, the decision module 220 may be configured to detect anomalous access requests based on the access scores not being beyond the threshold of conditions, i.e., the reasoning indicators not being validated using the relational parameters and response on the set of tasks. In such scenarios, access may be rejected.

In an embodiment, the outputs of the reasoning module 214, the relation module 216, and the task module 218 may be linked to corresponding weights. That is, the reasoning indicators from the relation module 216, the relational parameters from the relation module 216, and the response to the set of tasks from the task module 218 may be linked to corresponding weights. The weights may depend on sensitivity of the data, past accuracy, and/or past feedback. In an embodiment, the weights may be adjusted based on deep learning techniques. The decision module 220 may take into consideration the weights associated with outputs of the reasoning module 214, the relation module 216, and the task module 218 in order to dynamically grant access to the requester.

In an embodiment, the decision module 220 may be configured to take action on behalf of requester, wherein the action may be executed on a set of resources not previously accessed by the requester.

In an embodiment, the reasoning indicators identified for the access request by the reasoning module 214 based on events in the computing environment, e.g., events associated with the datastore 130, may be further associated with a dynamic lifespan. The lifespan of the determined reasoning indicators may be driven by real-time context evolution, in that, changes in the events or status updates related to the computing environment, the datastore 130, the requester 120, or other external systems linked to the computing environment may be continuously monitored and the context evolution in real-time may be determined. In an embodiment, the relational parameters (e.g., intent indicators) may evolve with time to cause change in context. Based on the context evolution, the processor 202 may dynamically determine the lifespan of the reasoning indicators, i.e., the valid reason for the request. In an embodiment, to grant access to the resources, the processor 202 may additionally take into account the determined lifespan such that the granted authorization may be configured to automatically decay or expire once the reasoning lifespan elapses. The determined lifespan may be defined in terms of unit time, e.g., seconds, minutes, hours, and so on. This dynamic decay ensures that access authorizations remain relevant, preventing prolonged permissions that could pose security risks.

In an embodiment, the requester, the resource, the events, the reasoning indicators, and the relational parameters (e.g., intent indicators) can be used to model automated replay of actions following a set of events. That is, the system 110 may model relationships between collected events, resources, reasons, intents, requester attributes, and historic actions performed, in order to predict a series of actions that follow a set of events, and then to replay the actions automatically.

FIG. 4 illustrates a process flow depicting a method 400 associated with the authorization system 110 for dynamically granting access to a requester when access policy is not defined and/or when the requester is unknown/new. The method 400 may be performed by the system 110, in particular, with the processor 202 in conjunction with the modules 210.

At step 402, the method includes receiving a request from the requester via the device 120 for accessing resource stored in the datastore 130.

At step 404, the method includes identifying a valid reason for the request based on events associated with the datastore 130, the device 120, and/or other external systems.

At step 406, the method includes determining whether the request relates to the events based on one or more patterns.

At step 408, the method includes determining the access level requested and the reasonable access required based on the historical one or more patterns as well as based on the reasoning.

At step 410, the method includes analysing response of the requester on a set of tasks.

At step 412, the method includes dynamically granting access to the requester based on the steps of reasoning, relations, and analysing responses.

It is to be noted that the details involved in the steps of the method have been detailed with reference to FIGS. 1-3 and have not been repeated herein for the sake of brevity.

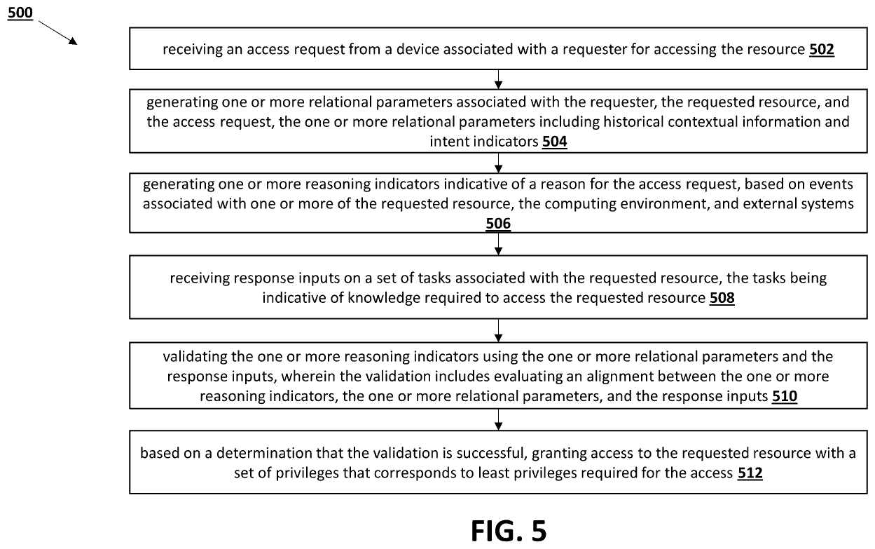

FIG. 5 illustrates a process flow depicting a method 500 associated with the system 110 for authorizing access to a resource in a computing environment. The method 500 may be performed by the system 110, in particular, with the processor 202 in conjunction with the modules 210.

At step 502, the method can include receiving an access request from the device 120 associated with a requester for accessing the resource.

In an embodiment, the resource may be stored in the datastore 130.

At step 504, the method can include generating one or more relational parameters associated with the requester, the requested resource, and the access request, the one or more relational parameters including historical contextual information and intent indicators.

In an embodiment, the intent indicators may be indicative of scope of the resource being requested, method of request, frequency of access, location of access, and extent of privileges requested.

In an embodiment, the historical contextual information may be associated with one or more of (a) the requester or other similar requesters, (b) the requested resource or similar resources, and (c) the access request or other similar access requests.

In an embodiment, the one or more relational parameters may further include one or more of temporal patterns, data patterns, access patterns, patterns related to the access request, patterns related to the events, patterns related to relations between the events and resources stored in the datastore, contextual evidence, and relational evidence

At step 506, the method can include generating one or more reasoning indicators indicative of a reason for the access request, based on events associated with one or more of the requested resource, the computing environment, and external systems.

In an embodiment, the one or more reasoning indicators may be associated with a dynamic lifespan, and the access granted may automatically decay or expire once the dynamic lifespan elapses.

At step 508, the method can include receiving response inputs on a set of tasks associated with the requested resource, the tasks being indicative of knowledge required to access the requested resource.

In an embodiment, the response inputs may be received from the device 120 associated with the requester. In an embodiment, the response inputs may be received from other systems, modules, or agents, in communication with the requester or the device 120.

In an embodiment, the method may further comprise providing the set of tasks associated with the resource to the requester.

In an embodiment, the set of tasks may be provided via the device 120 associated with the requester.

In an embodiment, the set of tasks can be a predefined set of tasks stored in the memory.

In an embodiment, the set of tasks can be dynamically generated set of tasks generated based on the access request and the relational parameters.

In an embodiment, the method may further comprise evaluating the correctness of the received response inputs on the set of tasks based on labelled outcomes in order to determine knowledge of the requester regarding the requested resource.

At step 510, the method can include validating the one or more reasoning indicators using the one or more relational parameters and the response inputs, wherein the validation can include evaluating an alignment between the one or more reasoning indicators, the one or more relational parameters, and the response inputs.

In an embodiment, validating the reasoning indicators by evaluating the alignment can comprise computing an access score for the one or more reasoning indicators based on the one or more relational parameters and the response inputs.

In an embodiment, the method may further comprise determining whether the access score exceeds a threshold indicative of a valid alignment between the one or more reasoning indicators, the one or more relational parameters, and the response inputs.

In an embodiment, the threshold may be defined in a proof of access graph.

In an embodiment, the proof of access graph may be a probabilistic model.

In an embodiment, validating the reasoning indicators may comprise determining validation to be successful when the access score exceeds the threshold and determining an unsuccessful validation when the access scores does not exceed the threshold.

At step 512, the method can include, based on a determination that the validation is successful, granting access to the requested resource with a set of privileges that corresponds to least privileges required for the access.

In an embodiment, granting access to the requested resource can comprise determining the least privileges based on the historical contextual data including past privileges granted for similar access requests.

In an embodiment, the method may further comprise denying access to the requested resource based on a determination that the validation is unsuccessful.

It is to be noted that the details involved in the steps of the method 500 have been detailed with reference to FIGS. 1-3 and have not been repeated herein for the sake of brevity.

Accordingly, an authorization system is provided for automated authorization to a requester in a heterogeneous environment where access policies may not be defined and/or the requester may be completely unknown. The authorization system facilitates a just-in-time authorisation to a requested resource, after proper and valid reasoning, intent, and requester knowledge is established. Using ‘reasoning discovery’ and ‘intent discovery’, automated authorisation can be allowed or automated actions on behalf of another user can be allowed. The authorization system as described thus provides a more secure alternative to the conventional password based or multi-factor authentication (MFA) based systems.

While specific language has been used to describe the present disclosure, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

It will be appreciated that the modules, processes, systems, and devices described above can be implemented in hardware, hardware programmed by software, software instruction stored on a non-transitory computer readable medium or a combination of the above. Embodiments of the methods, processes, modules, devices, and systems (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the methods, systems, or computer program products (software program stored on a non-transitory computer readable medium).

Furthermore, embodiments of the disclosed methods, processes, modules, devices, systems, and computer program product may be readily implemented, fully or partially, in software using, for example, object or object-oriented software development environments that provide portable source code that can be used on a variety of computer platforms. Alternatively, embodiments of the disclosed methods, processes, modules, devices, systems, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the invention to produce additional embodiments. Furthermore, certain features may sometimes be used to advantage without a corresponding use of other features.

1. A computer-implemented method for authorizing access to a resource in a computing environment, comprising:
receiving an access request from a device associated with a requester for accessing the resource;
generating one or more relational parameters associated with the requester, the requested resource, and the access request, the one or more relational parameters including historical contextual information and intent indicators;
generating one or more reasoning indicators indicative of a reason for the access request, based on events associated with one or more of the requested resource, the computing environment, and external systems;
receiving response inputs on a set of tasks associated with the requested resource, the tasks being indicative of knowledge required to access the requested resource;
validating the one or more reasoning indicators using the one or more relational parameters and the response inputs, wherein the validation includes evaluating an alignment between the one or more reasoning indicators, the one or more relational parameters, and the response inputs; and
based on a determination that the validation is successful, granting access to the requested resource with a set of privileges that corresponds to least privileges required for the access.

2. The method according to claim 1, wherein validating the reasoning indicators by evaluating the alignment comprises:
computing an access score for the one or more reasoning indicators based on the one or more relational parameters and the response inputs, and
determining whether the access score exceeds a threshold indicative of a valid alignment between the one or more reasoning indicators, the one or more relational parameters, and the response inputs, the threshold being defined in a proof of access graph, the proof of access graph being a probabilistic model.

3. The method according to claim 2, wherein validating the reasoning indicators comprises determining validation to be successful when the access score exceeds the threshold and determining an unsuccessful validation when the access scores does not exceed the threshold.

4. The method according to claim 1, wherein granting access to the requested resource comprises determining the least privileges based on the historical contextual data including past privileges granted for similar access requests.

5. The method according to claim 1, comprising denying access to the requested resource based on a determination that the validation is unsuccessful.

6. The method according to claim 1, comprising:
providing the set of tasks associated with the resource to the requester, wherein the set of tasks is one of (a) a predefined set of tasks stored in a memory, or (b) a dynamically generated set of tasks based on the access request and the relational parameters; and
evaluating the correctness of the received response inputs on the set of tasks based on labelled outcomes in order to determine knowledge of the requester regarding the requested resource.

7. The method according to claim 1, wherein the one or more reasoning indicators are associated with a dynamic lifespan, and the access granted automatically decays or expires once the dynamic lifespan elapses.

8. The method according to claim 1, wherein the intent indicators are indicative of scope of the resource being requested, method of request, frequency of access, location of access, and extent of privileges requested.

9. The method according to claim 1, wherein the historical contextual information is associated with one or more of (a) the requester or other similar requesters, (b) the requested resource or similar resources, and (c) the access request or other similar access requests.

10. The method according to claim 1, wherein the one or more relational parameters further include one or more of temporal patterns, data patterns, access patterns, patterns related to the access request, patterns related to the events, patterns related to relations between the events and resources stored in a datastore, contextual evidence, and relational evidence.

11. A system for authorizing access to a resource in a computing environment, the system comprising:
one or more processors; and
a memory storing instructions that, when executed by the one or more processors, cause the one or more processors to:
receive an access request from a device associated with a requester for accessing the resource;
generate one or more relational parameters associated with the requester, the requested resource, and the access request, the one or more relational parameters including historical contextual information and intent indicators;
generate one or more reasoning indicators indicative of a reason for the access request, based on events associated with one or more of the requested resource, the computing environment, and external systems;
receive response inputs on a set of tasks associated with the requested resource, the tasks being indicative of knowledge required to access the requested resource;
validate the one or more reasoning indicators using the one or more relational parameters and the response inputs, wherein the validation includes evaluating an alignment between the one or more reasoning indicators, the one or more relational parameters, and the response inputs; and
based on a determination that the validation is successful, grant access to the requested resource with a set of privileges that corresponds to least privileges required for the access.

12. The system according to claim 11, wherein to validate the reasoning indicators by evaluating the alignment, the one or more processors are configured to:
compute an access score for the one or more reasoning indicators based on the one or more relational parameters and the response inputs, and
determine whether the access score exceeds a threshold indicative of a valid alignment between the one or more reasoning indicators, the one or more relational parameters, and the response inputs, the threshold being defined in a proof of access graph, the proof of access graph being a probabilistic model.

13. The system according to claim 12, wherein to validate the reasoning indicators, the one or more processors are configured to determine validation to be successful when the access score exceeds the threshold and determine an unsuccessful validation when the access scores does not exceed the threshold.

14. The system according to claim 11, wherein to grant access to the requested resource, the one or more processors are configured to determine the least privileges based on the historical contextual data including past privileges granted for similar access requests.

15. The system according to claim 11, wherein the one or more processors are configured to deny access to the requested resource based on a determination that the validation is unsuccessful.

16. The system according to claim 11, wherein the one or more processors are configured to:
provide the set of tasks associated with the resource to the requester, wherein the set of tasks is one of (a) a predefined set of tasks stored in a memory, or (b) a dynamically generated set of tasks based on the access request and the relational parameters; and
evaluate the correctness of the received response inputs on the set of tasks based on labelled outcomes in order to determine knowledge of the requester regarding the requested resource.

17. The system according to claim 11, wherein the one or more reasoning indicators are associated with a dynamic lifespan, and the access granted automatically decays or expires once the dynamic lifespan elapses.

18. The system according to claim 11, wherein the intent indicators are indicative of scope of the resource being requested, method of request, frequency of access, location of access, and extent of privileges requested, and
wherein the historical contextual information is associated with one or more of (a) the requester or other similar requesters, (b) the requested resource or similar resources, and (c) the access request or other similar access requests.

19. The system according to claim 11, wherein the one or more relational parameters further include one or more of temporal patterns, data patterns, access patterns, patterns related to the access request, patterns related to the events, patterns related to relations between the events and resources stored in a datastore, contextual evidence, and relational evidence.

20. A non-transitory computer-readable storage medium comprising instructions executable by a processor, the instructions to cause the processor to perform or control performance of operations that comprise:
receiving an access request from a device associated with a requester for accessing a resource in a computing environment;
generating one or more relational parameters associated with the requester, the requested resource, and the access request, the one or more relational parameters including historical contextual information and intent indicators;
generating one or more reasoning indicators indicative of a reason for the access request, based on events associated with one or more of the requested resource, the computing environment, and external systems;
receiving response inputs on a set of tasks associated with the requested resource, the tasks being indicative of knowledge required to access the requested resource;
validating the one or more reasoning indicators using the one or more relational parameters and the response inputs, wherein the validation includes evaluating an alignment between the one or more reasoning indicators, the one or more relational parameters, and the response inputs; and
based on a determination that the validation is successful, granting access to the requested resource with a set of privileges that corresponds to least privileges required for the access.
